(19) United States
(12) Patent Application Publication
(10) Pub. No.: US 2021/0295273 A1
(43) Pub. Date: Sep. 23, 2021

(54) TERMINAL AND NON-TRANSITORY COMPUTER READABLE STORAGE MEDIUM

(71) Applicants: BEIJING BOE TECHNOLOGY DEVELOPMENT CO., LTD., Beijing (CN); BOE TECHNOLOGY GROUP CO., LTD., Beijing (CN)

(72) Inventor: Wenbo LI, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 17/264,834

(22) PCT Filed: Jun. 22, 2020
(86) PCT No.: PCT/CN2020/097423

§ 371 Date: Jan. 31, 2021

(30) Foreign Application Priority Data
Jun. 20, 2019 (CN) 201910538690.9

(51) Int. Cl. G06Q 10/10; G06K 9/00

(52) U.S. Cl. CPC G06Q 10/1095; G06K 2209/01; G06K 9/00442

(57) ABSTRACT

A terminal and a non-transitory computer readable storage medium are provided in the present disclosure. The terminal includes a display, a memory and a processor. The memory stores program codes capable of implementing the following functions: a calendar management module, a note management module, a business card management module and an association relationship management module. The processor is configured to execute the program codes of the calendar management module, the note management module, the business card management module and the association relationship management module. The display is configured to display information outputted by the calendar management module, the note management module, the business card management module and the association relationship management module, and acquire input information according to an operation of a user on the display.

### CROSS-REFERENCE TO RELATED APPLICATION

This application claims a priority to Chinese Patent Application No. 201910538690.9 filed on Jun. 20, 2019, the disclosure of which is incorporated in its entirety by reference herein.

### TECHNICAL FIELD

The present disclosure relates to the field of meeting management technologies, in particular to a terminal and a non-transitory computer readable storage medium.

### BACKGROUND

In people's daily work, a paper notebook distributed by a company is usually used to record important items, such as a project team meeting, a weekly meeting, a study meeting, a patent mining meeting, and a list of personal important items. With the increase of working hours, paper notebooks pile up like a mountain, and all kinds of the information is so intricate and messy that it cannot form effective knowledge reuse.

### SUMMARY

In a first aspect, a terminal is provided, including: a display, a memory and a processor. The memory stores program codes capable of implementing the following functions: a calendar management module, a note management module, a business card management module and an association relationship management module. The processor is configured to execute the program codes of the calendar management module, the note management module, the business card management module and the association relationship management module. The display is configured to display information outputted by the calendar management module, the note management module, the business card management module and the association relationship management module, and acquire input information according to an operation of a user on the display. The calendar management module is configured to receive meeting information stored according to time on a calendar sent by a server when executed by the processor. The meeting information includes at least one of time of a meeting, a location of the meeting, a type of the meeting, a topic of the meeting, or attendees. The note management module is configured to receive meeting association information associated with the meeting information sent by the server when executed by the processor. The business card management module is configured to receive personal information of an attendee sent by the server when executed by the processor. The association relationship management module is configured to receive an association relationship sent by the server when executed by the processor. The association relationship is an association relationship among the meeting information, the meeting association information and the personal information of the attendee.

According to an embodiment of the present disclosure, the calendar management module includes: a time association sub-module, configured to establish an association relationship between the received meeting information and the time on the calendar when executed by the processor; and a meeting abstract viewing sub-module, configured to receive meeting abstract information, and acquire the meeting information from the meeting abstract information when executed by the processor. The meeting abstract information includes at least one of the time of the meeting, the location of the meeting, the type of the meeting, the topic of the meeting, or the attendees.

According to an embodiment of the present disclosure, the terminal further includes: a meeting link generation module, configured to generate a meeting link associated with the meeting information when executed by the processor; and a meeting link processing module, configured to receive the meeting information corresponding to the meeting link when executed by the processor.

According to an embodiment of the present disclosure, the note management module includes: a multi-media information acquisition sub-module, configured to acquire multi-media information associated with the meeting information when executed by the processor; where the multi-media information includes at least one of a picture of the meeting, a video of the meeting or an audio of the meeting; and a meeting note acquisition sub-module, configured to acquire a meeting collection note associated with the meeting information when executed by the processor.

According to an embodiment of the present disclosure, the terminal further includes: a first image acquisition module and a first image identification module. The first image acquisition module is configured to acquire a note image of a recorded note corresponding to the meeting information.

The first image identification module is configured to identify the note image and acquire the meeting collection note.

According to an embodiment of the present disclosure, the terminal further includes: a second image acquisition module and a second image identification module. The second image acquisition module is configured to acquire a personal information image of the attendee. The second image identification module is configured to identify the personal information image and acquire the personal information of the attendee.

According to an embodiment of the present disclosure, the terminal further includes: an information exchange module and an information sharing module. The information exchange module is configured to perform information exchange with at least one second user through attendee information of the at least one second user for a first user when executed by the processor, and the attendee information includes business card information of the attendee. The information sharing module is configured to share meeting-attended information and business card information of the first user with the at least one second user when executed by the processor, and the meeting-attended information includes at least one of meeting audio and video information, or collection note information.

According to an embodiment of the present disclosure, the business card management module includes: a business card information output sub-module, configured to output business card information of the attendees to the display when executed by the processor.

According to an embodiment of the present disclosure, the terminal further includes: an output module, configured to output the meeting information, the meeting association information and the personal information of the attendee to the display when executed by the processor.

In a second aspect, a server is further provided, including: a memory, a processor and a computer program stored on the memory and capable of running on the processor. The computer program is executed by the processor to implement: sending meeting information stored according to time on a calendar to a terminal, where the meeting information includes at least one of time of a meeting, a location of the meeting, a type of the meeting, a topic of the meeting, or attendees; sending meeting association information associated with the meeting information to the terminal; sending personal information of an attendee to the terminal; and sending an association relationship to the terminal, where the association relationship is an association relationship among the meeting information, the meeting association information and the personal information of the attendee.

In a third aspect, a non-transitory computer readable storage medium having a computer program stored thereon is further provided, the computer program is executed by a processor to implement: receiving meeting information stored according to time on a calendar sent by a server, where the meeting information includes at least one of time of a meeting, a location of the meeting, a type of the meeting, a topic of the meeting, or attendees; receiving meeting association information associated with the meeting information sent by the server; receiving personal information of an attendee sent by the server; and receiving an association relationship sent by the server, where the association relationship is an association relationship among the meeting information, the meeting association information and the personal information of the attendee.

In a fourth aspect, a non-transitory computer readable storage medium having a computer program stored thereon is further provided, the computer program is executed by a processor to implement: sending meeting information stored according to time on a calendar to a terminal, where the meeting information includes at least one of time of a meeting, a location of the meeting, a type of the meeting, a topic of the meeting, or attendees; sending meeting association information associated with the meeting information to the terminal; sending personal information of an attendee to the terminal; and sending an association relationship to the terminal, where the association relationship is an association relationship among the meeting information, the meeting association information and the personal information of the attendee.

### BRIEF DESCRIPTION OF THE DRAWINGS

FIG. 1 is a schematic structural diagram of a terminal according to an embodiment of the present disclosure;

FIG. 2 is a schematic diagram of an interface of the terminal according to an embodiment of the present disclosure;

FIG. 3 is a schematic diagram of searching a meeting according to an embodiment of the present disclosure;

FIG. 4 is a schematic diagram of searching a meeting according to an embodiment of the present disclosure;

FIG. 5 is a schematic diagram of a list of meetings acquired by searching according to an embodiment of the present disclosure;

FIG. 6 is a schematic diagram of business card information of attendees according to an embodiment of the present disclosure;

FIG. 7 is a schematic diagram of a detailed business card information according to an embodiment of the present disclosure;

FIG. 8 is a schematic diagram of a desktop calendar according to an embodiment of the present disclosure;

FIG. 9 is a flowchart of steps of a meeting management method according to an embodiment of the present disclosure;

FIG. 10 is a flowchart of steps of the meeting management method according to another embodiment of the present disclosure;

FIG. 11 is a schematic structural diagram of a terminal according to an embodiment of the present disclosure;

FIG. 12 is a schematic structural diagram of a terminal according to an embodiment of the present disclosure; and

FIG. 13 is a schematic diagram of a hardware structure of a terminal according to an embodiment of the present disclosure.

### DETAILED DESCRIPTION

In order to make the objects, the features and the advantages of the present disclosure more apparent, a detailed description will be given below with reference to the accompanying drawings and specific embodiments.

A terminal, a server, and a meeting management method are provided in the present disclosure, to solve a problem that various information are intricately and disorderly when paper notebooks are used in the related art, and effective knowledge reuse may not be performed.

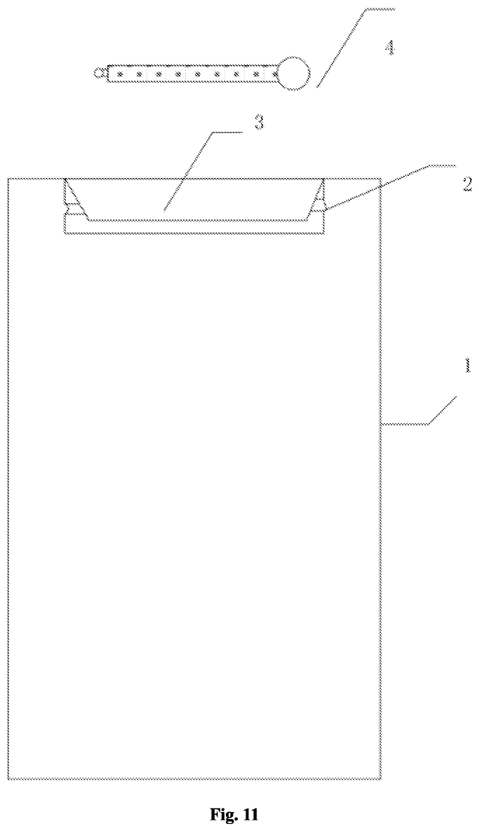

FIG. 11 is a schematic structural diagram of a terminal according to an embodiment of the present disclosure. The terminal includes a display screen, an electronic pen slot, an electronic pen, a clip that cooperates with the electronic pen slot to fix the electronic pen and a side slot. The display screen is used to display information outputted by the terminal and acquire input information according to a click operation of a user.

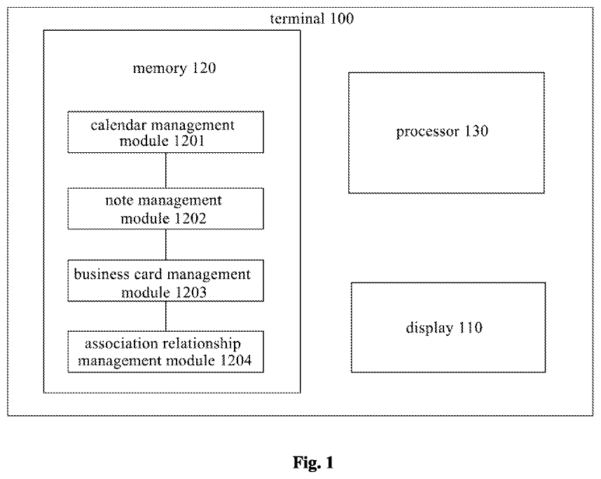

FIG. 1 is a schematic structural diagram of a terminal according to an embodiment of the present disclosure. As shown in FIG. 1, a terminal 100 includes: a display 110, a memory 120 and a processor 130. The memory 130 stores program codes capable of implementing the following functions: a calendar management module 1201, a note management module 1202, a business card management module 1203 and an association relationship management module 1204. The processor is configured to execute the program codes of the calendar management module 1201, the note management module 1202, the business card management module 1203 and the association relationship management module 1204. The display 110 is configured to display information outputted by the calendar management module 1201, the note management module 1202, the business card management module 1203 and the association relationship management module 1204, and acquire input information according to an operation of a user on the display. The calendar management module 1201 is configured to receive meeting information stored according to time on a calendar sent by a server when executed by the processor. The meeting information includes at least one of time of a meeting, a location of the meeting, a type of the meeting, a topic of the meeting, or attendees. The note management module 1202 is configured to receive meeting association information associated with the meeting information sent by the server when executed by the processor. The business card management module 1203 is configured to receive personal information of an attendee sent by the server when executed by the processor. The association relationship management module 1204 is configured to receive an association relationship sent by the server when executed by the processor. The association relationship is an association relationship among the meeting information, the meeting association information and the personal information of the attendee.

According to the embodiment of the present disclosure, the terminal further includes: an output module, configured to output the meeting information, the meeting association information and the personal information of the attendee processed and acquired by the server when executed by the processor

In the embodiment of the present disclosure, the meeting may be a work weekly meeting, a manufacturer meeting, a study meeting, a technical seminar, etc. Specifically, the meeting may be determined according to practical applications, which is not defined in the embodiment of the present disclosure.

The meeting information may include the time of the meeting (such as xx (time point) on xx (month) xx (day), xxx (year), etc.), the location of the meeting (such as room xx, xx building xx floor, etc.). Of course, the meeting information may further include at least one of the topic of the meeting (such as “Brightness enhancement film technical seminar”, “Intellectual property technology study”), the attendees (such as a list of attendees), attending companies (such as xx company, enterprise xx), or other information. Specifically, the meeting information may be determined based on service requirements, which is not defined in the embodiment of the present disclosure.

The meeting association information may include one or more of the meeting note information, meeting audio and video information, or other information recorded by the user during the meeting. Specifically, the meeting association information may be determined based on service requirements, which is not defined in the embodiment of the present disclosure.

The personal information of the attendee may include such as a name, a phone number, a landline number, an email address and an address of the attendee, and a company where the attendee works.

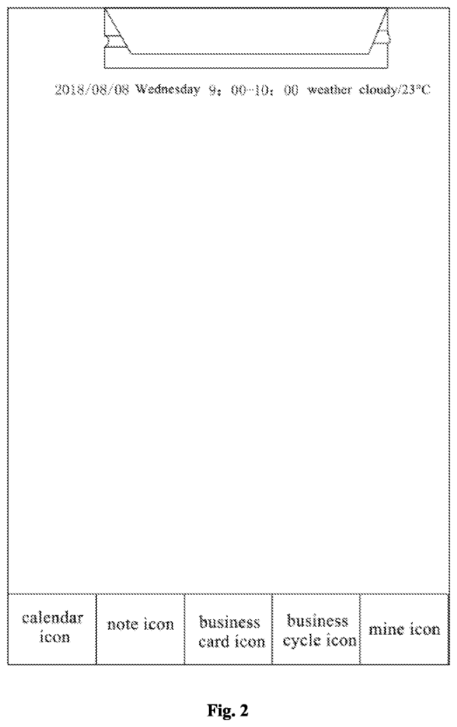

FIG. 2 is a schematic diagram of an interface of the terminal according to an embodiment of the present disclosure. As shown in FIG. 2, there are a calendar icon, a note icon, and a business card icon displayed on a home page of the terminal, corresponding to the calendar management module 1201, the note management module 1202 and the business card management module 1203 respectively. Each module corresponds to an operation button. When a button is selected through the display of the terminal, such an operation as adding, recording, or viewing meeting association information may be performed.

The terminal 100 may further include the association relationship management module 1204, configured to receive the association relationship sent by the server. The association relationship is the association relationship among the meeting information, the meeting association information and the personal information of the attendee. The association relationship management module 1204 corresponds to a business circle icon displayed on the home page of the terminal.

A process of establishing the association relationship may be: adding same meeting association information to the meeting information, the meeting association information and the personal information of the attendee to establish the association relationship among the meeting information, the meeting association information and the personal information of the attendee. For example, meeting topic information is added to the meeting information, the meeting association information and the personal information of the attendee simultaneously, and the meeting information, the meeting association information and the personal information of the attendee may be associated according to the meeting topic information. Or, the personal information of the attendee or information of a company attending the meeting is added to the meeting information, the meeting association information and the personal information of the attendee simultaneously, so as to associate the meeting information, the meeting association information and the personal information of the attendee.

The process of establishing the association relationship may also be: extracting a first keyword of the meeting information, extracting a second keyword of the meeting association information, and extracting a third keyword of the personal information of the attendee, and then establishing an association relationship among the first keyword, the second keyword and the third keyword. Thus, the meeting information, the meeting association information and the personal information of the attendee are associated through keywords.

For example, if the first keyword is A company, the second keyword is also A company, and the third keyword is also A company, the meeting information, the meeting association information and the personal information of the attendee may be associated through A company. That is, a company attending the meeting is A company, the meeting note information in the meeting association information includes relevant information of A company, and a company where the attendee works is A company. Through a keyword A company, it may be acquired that whether A company attends the meeting, what is the relevant information of A company, and which person of A company attend the meeting.

In addition, whether to display date, day of a week, time point, weather and other information may be further set on the home page.

It should be appreciated that, the above-mentioned examples are only examples for better understanding of technical solutions of the embodiments of the present disclosure, and are not to be construed as limiting the embodiments of the present disclosure.

After the association relationship among the meeting information, the meeting association information and the personal information of the attendee has been established by the association relationship management module 1204, the association relationship may be stored. The association relationship may be stored in a pre-established database, or a preset file.

The unified storage and management of the meeting association information may be achieved in the embodiments of the present disclosure. When searching for the meeting information later, the corresponding meeting association information may be searched directly based on the established association relationship. The meeting information is organized and clear, and the search process is simple, thereby improving the efficiency of searching the meeting information.

In the following process, the terminal 100 in the present disclosure will be described in detail with reference to specific implementations as follows.

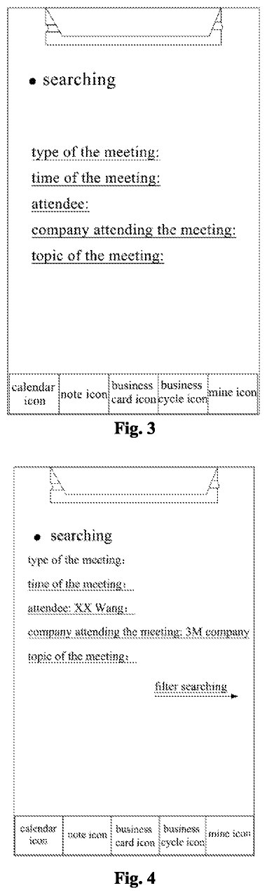

According to some embodiments of the present disclosure, a searching function may be achieved on the terminal. Specifically, a detailed description will be given below with reference to FIG. 3 to FIG. 5.

In the embodiment of the present disclosure, a searching function may be achieved on the terminal 100. FIG. 3 and FIG. 4 are schematic diagrams of searching a meeting according to the embodiment of the present disclosure. As shown in FIG. 3, when a search button on the interface is clicked by the user, such items as a type of a meeting, time of the meeting, attendees, a company attending the meeting, and a topic of the meeting may be displayed on the interface. A content to be searched may be inputted by the user according to one or more of the items. As shown in FIG. 4, an attendee, i.e., XX Wang, and a company attending the meeting, i.e., 3M company, are inputted by the user, and then related meetings may be searched based on two items inputted by the user.

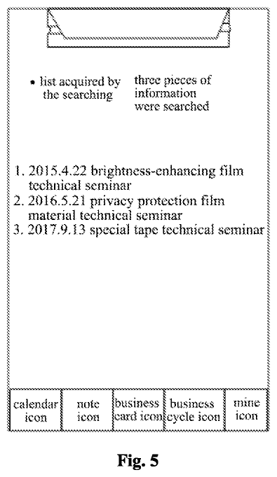

After the searching has been performed, the related meetings may be displayed on a screen interface of the terminal 100. When the related meetings include multiple items, all the related meetings may be displayed. FIG. 5 is a schematic diagram of a list of meetings acquired by the searching according to the embodiment of the present disclosure. As shown in FIG. 5, when the searched meetings include three meetings, such as “1. 2015.4.22 brightness-enhancing film technical seminar”, “2. 2016.5.21 privacy protection film material technical seminar”, and “3. 2017.9.13 special tape technical seminar”, all the three meetings may be displayed on the interface. One item may be clicked by the user base on needs to achieving viewing of specific meeting content information.

According to an embodiment of the present disclosure, the calendar management module 1201 may include: a time association sub-module and a meeting abstract viewing sub-module.

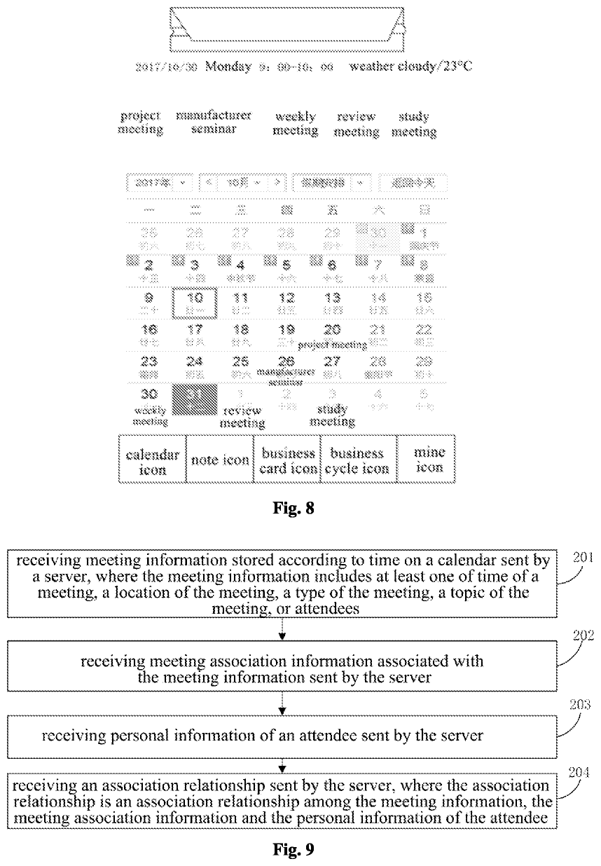

The time association sub-module is configured, when executed by the processor, to establish an association relationship between the received meeting information and the time on the calendar. According to the association relationship between the time of the meeting and the time on the calendar, an association relationship between the meeting information and the time on the calendar may be established, and the topic of the meeting information may be displayed on a time icon corresponding to the time on the calendar through an output device, such as the display. FIG. 8 is a schematic diagram of a desktop calendar according to an embodiment of the present disclosure. As shown in FIG. 8, when establishing the association relationship between a target meeting and the time on the calendar, a topic of the target meeting may be displayed on a time icon corresponding to the time on the calendar, such as October 20: a project meeting, October 26: a manufacturer seminar, October 30: a weekly meeting, November 1: a review meeting, November 3: a study meeting.

The meeting abstract viewing sub-module is configured, when executed by the processor, to receive meeting abstract information, and acquire the meeting information from the meeting abstract information. The meeting abstract information includes at least one of the time of the meeting, the location of the meeting, the type of the meeting, the topic of the meeting, or the attendees.

When receiving a click operation of the user on the time icon through the display, the meeting abstract information is displayed on a display interface.

In the embodiment of the present disclosure, the meeting abstract information includes one or more of the type of the meeting, the time of the meeting, the location of the meeting, or the topic of the meeting.

The time icon is an icon that may be clicked. The time icon may be connected to the note management module 120. After the time icon has been clicked, meeting content association information received by the note management module 120 may be displayed. For example, after one of October 20: a project meeting, October 26: a manufacturer seminar, October 30: a weekly meeting, November 1: a review meeting, November 3: a study meeting has been clicked, meeting content information of the corresponding meeting may be directly displayed on a display interface of a meeting notebook.

According to another embodiment of the present disclosure, the terminal 100 may further include: a meeting link generation module and a meeting link processing module. The meeting link generation module is configured, when executed by the processor, to generate a meeting link associated with the meeting information, and the meeting link processing module is configured, when executed by the processor, to receive meeting information corresponding to the meeting link.

In the embodiment of the present disclosure, the meeting link is referred to as a link address corresponding to a meeting. After the link address is clicked by the user through the display screen, a preview interface showing the meeting information of the meeting may be directly jumped to.

An information preview interface is referred to as an interface used to display the meeting information.

After the meeting link generation module has generated the meeting link associated with the meeting information, when the meeting link processing module receives a click operation of the user corresponding to the meeting link, the meeting information may be displayed on the information preview interface.

According to another embodiment of the present disclosure, the note management module 1202 may include: a multi-media information acquisition sub-module and a meeting note acquisition sub-module. The multi-media information acquisition sub-module is configured, when executed by the processor, to acquire multi-media information associated with the meeting information. The meeting note acquisition sub-module is configured, when executed by the processor, to acquire a meeting collection note associated with the meeting information.

In the embodiment of the present disclosure, the multi-media information may include one or more of a picture of the meeting, a video of the meeting or an audio of the meeting.

The picture of the meeting may be a photo taken by the attendee during the meeting, or a photo taken by an organizer of the meeting in advance to promote the meeting. Specifically, the specific type of the picture of the meeting may be determined according to practical applications, which is not defined in the embodiment of the present disclosure.

The video of the meeting may be a video file recorded by the attendee during the meeting, so that the user may replay the meeting in a later use process. The user may clip the video to extract an important content of the meeting. The video of the meeting may also be a video file recorded by the organizer of the meeting in advance to promote the meeting. Specifically, the specific type of the video of the meeting may be determined according to practical applications, which is not defined in the embodiment of the present disclosure.

The audio of the meeting may be an audio file recorded by the attendee during the meeting, so that the user may replay the meeting in a later use process. The user may clip the audio to extract an important content of the meeting.

The meeting collection note is referred to as a meeting note recorded by the user during the meeting. When recording the meeting note, the meeting note may be inputted by the user through a touch screen of the terminal, or through an electronic pen moving on the touch screen, so as to be the meeting note recorded by the user, thereby facilitating the user of viewing relevant content of the meeting later.

After the meeting collection note associated with the meeting information has been acquired by the user, the meeting note acquisition sub-module may acquire and store the meeting collection note.

A specific manner of recording the meeting collection note may be described with reference to the following specific implementation.

According to another embodiment of the present disclosure, the terminal 100 may further include: a first image acquisition module and a first image identification module. The first image acquisition module is configured to acquire a note image of a recorded note corresponding to the meeting information. The first image identification module is configured to identify the note image and acquire the meeting collection note.

Specifically, the first image identification module may identify the note image by using an optical character recognition technology to acquire the meeting collection note.

In the embodiment of the present disclosure, a camera may further be set on the meeting notebook. That is, the camera is regarded as the first image acquisition module. After the meeting has been finished, if the user has forgot to record a content of the meeting, the camera may be used to capture a meeting note (i.e., the recorded note) recorded by another attendee, so as to acquire the note image.

Optical character recognition (OCR) is referred to as a process where an electronic device (such as a scanner or a digital camera) detects a character printed on a paper, determines a shape of the character by detecting dark and bright patterns of the character, and then translates the shape into computer text by using a character recognition method. After the note image has been acquired, the first image identification module may identify the note image by using the OCR technology to acquire the meeting collection note in the note image, and store the meeting collection note.

Of course, in the embodiment of the present disclosure, it is not limited to the meeting notes recorded by other users. It may also be a note meeting recorded by the user manually when the user has forgot to carry the meeting notebook in the present disclosure. The first image acquisition module may acquire a note image corresponding to the note meeting recorded by the user, and the first image identification module may identify the note image and acquire text information in the note image, so as to acquire and store the meeting collection note.

The first image acquisition module and the first image identification module are provided to solve a problem that the meeting note recorded manually by the user is required to be inputted to the meeting notebook manually, thereby reducing a workload of the user, and saving time for the user inputting the meeting note.

According to another embodiment of the present disclosure, the terminal 100 may further include: a second image acquisition module and a second image identification module. The second image acquisition module may be configured to acquire a personal information image of the attendee. The second image identification module may be configured to identify the personal information image and acquire the personal information of the attendee.

Specifically, the second image identification module may identify the personal information image by using the optical character recognition technology to acquire the personal information of the attendee.

The personal information image may be a personal information image acquired by collecting the attendee displayed before the meeting, or a personal information image acquired by capturing a paper business card after the user has received the paper business card of another attendee. Specifically, the personal information image may be determined according to practical applications, which is not defined in the embodiment of the present disclosure.

The second image acquisition module may be a device such as a camera set on the meeting notebook in the present disclosure, and the personnel information image may be collected by turning on the camera.

The second image identification module is a function realized by computer program codes, and may identify the text information in the personal information image by using the OCR technology, so as to extract the personal information of the attendee for storage.

In a specific implementation of the present disclosure, the terminal may include an image acquisition device. The image acquisition device may be an image acquisition apparatus such as a camera.

The image acquisition device may be configured to acquire the note image of the recorded note corresponding to the meeting information. After the meeting has been finished, if the user has forgot to record the content of the meeting, the camera may be used to capture a meeting note (i.e., the recorded note) recorded by another attendee, so as to acquire the note image.

The image acquisition device may be configured to acquire the personal information image of the attendee.

The personal information image may be a personal information image acquired by collecting the attendee displayed before the meeting, or a personal information image acquired by capturing a paper business card after the user has received the paper business card of another attendee. Specifically, the personal information image may be determined according to practical applications, which is not defined in the embodiment of the present disclosure.

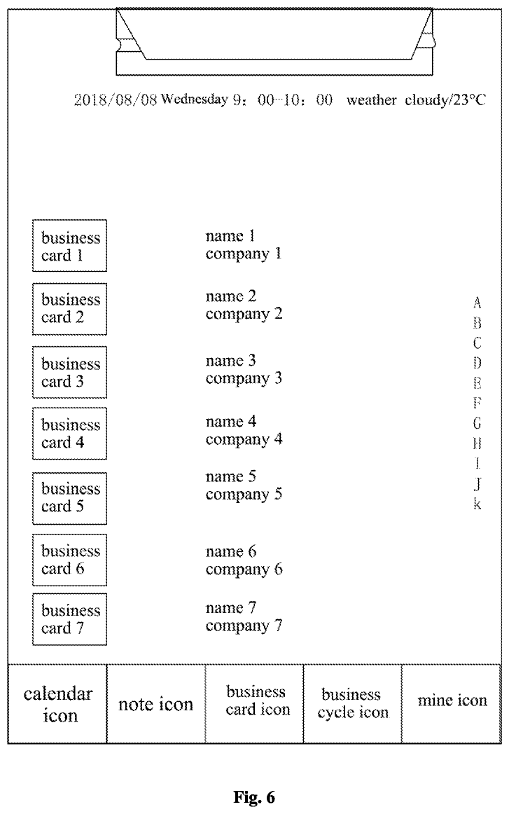

FIG. 6 is a schematic diagram of business card information of attendees according to an embodiment of the present disclosure. After the personnel information images corresponding to all the attendees have been identified, information of the attendees, such as business card 1: name 1, company 1, business card 2: name 2, company 2; business card 3: name 3, company 3; . . . business card 7: name 7, company 7, may be displayed on a page of the meeting notebook.

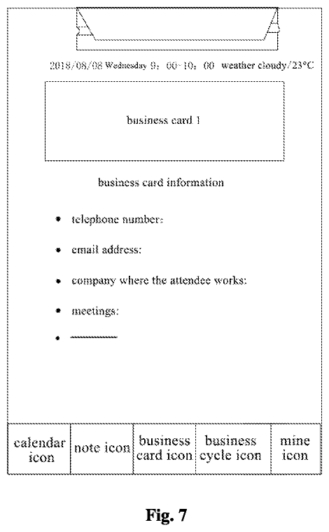

FIG. 7 is a schematic diagram of a detailed business card information according to an embodiment of the present disclosure. As shown in FIG. 7, detailed business card information of the business card 1 may include: a telephone number, an email address, a company where the attendee works, meetings (i.e., which meetings the name 1 has attended).

It should be appreciated that the above-mentioned examples are only examples for better understanding of the technical solutions of the embodiments of the present disclosure, and are not to be construed as limiting the embodiments of the present disclosure.

Specifically, in the present disclosure, the business card management module 1203 may further include the business card information output sub-module, configured to output the business card information of the attendees to the display. Specifically, the business card information of the attendees may be displayed when receiving a business card information display instruction according to an operation of the user on the display.

In the embodiment of the present disclosure, the display instruction may be an instruction for displaying the business card information triggered when the user clicks a business card of an attendee, or an instruction for displaying the business card information triggered by a voice inputted by the user. The specific form of the display instruction may be determined according to service requirements, which is not defined in the embodiment of the present disclosure.

For example, for the multiple business cards shown in FIG. 6, when the business card 1 is clicked by the user, detailed business card information of the business card 1 as shown in FIG. 7 may be displayed on a page corresponding to the meeting notebook.

It should be appreciated that the above-mentioned examples are only examples for better understanding of the technical solutions of the embodiments of the present disclosure, and are not to be construed as limiting the embodiments of the present disclosure.

According to another embodiment of the present disclosure, the terminal 100 may further include: an information sharing module and an information exchange module. The information exchange module is configured, when executed by the processor, to perform information exchange with at least one second user through attendee information of the at least one second user for a first user, and the attendee information includes business card information of the attendees. The information sharing module is configured, when executed by the processor, to share meeting-attended information and business card information of the first user with the at least one second user.

In the embodiment of the present disclosure, the first user is referred to as a user who currently needs to perform information exchange, and the second user is referred to as another user attending the target meeting. It should be appreciated that, both the first user and the second user are persons attending the target meeting. When the first user needs to perform information exchange with the at least one second user attending the target meeting, the information exchange module may perform information exchange with the at least one second user based on the attendee information of the at least one second user. For example, the first user may make a phone call with the second user based on a telephone number or a landline number in the attendee information of the at least one second user, or the first user may send and receive messages to and from the second user based on QQ information in the attendee information the at least one second user.

The meeting-attended information may include one or more of audio and video information, or collection note information.

When the first user performs information exchange with the at least one second user, the meeting-attended information and the business card information of the first user may further be shared with the at least one second user, for example, via QQ, WeChat, Weibo, and email, etc.

It should be appreciated that the above-mentioned examples are only examples for better understanding of the technical solutions of the embodiments of the present disclosure, and are not to be construed as limiting the embodiments of the present disclosure.

In some embodiments of the present disclosure, the terminal may be a mobile phone, a tablet personal computer, a laptop computer, a personal digital assistant (PDA), a mobile Internet device (MID) or a wearable device, etc.

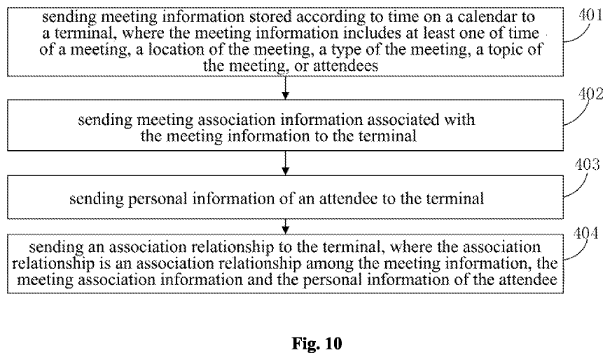

FIG. 9 is a flowchart of steps of a meeting management method according to an embodiment of the present disclosure. As shown in FIG. 9, the meeting management method may specifically include: step 201, receiving meeting information stored according to time on a calendar sent by a server, where the meeting information includes at least one of time of a meeting, a location of the meeting, a type of the meeting, a topic of the meeting, or attendees, step 202, receiving meeting association information associated with the meeting information sent by the server, step 203, receiving personal information of an attendee sent by the server, and step 204, receiving an association relationship sent by the server, where the association relationship is an association relationship among the meeting information, the meeting association information and the personal information of the attendee.

Optionally, the step 201 includes: establishing an association relationship between the meeting information and the time on the calendar according to an association relationship between the time of the meeting and the time on the calendar, and displaying a topic of the meeting at a time icon corresponding to the time on the calendar; and receiving meeting abstract information, and acquiring the meeting information from the meeting abstract information.

Specifically, when receiving a click operation of the user on the time icon, the meeting abstract information of the meeting information is displayed on a display interface. The meeting abstract information includes at least one of the time of the meeting, the location of the meeting, the type of the meeting, the topic of the meeting, or the attendees.

Optionally, the method further includes: generating a meeting link associated with the meeting information, and receiving a program of the meeting information corresponding to the meeting link.

Optionally, the step 202 includes: acquiring multi-media information associated with the meeting information, where the multi-media information includes at least one of a picture of the meeting, a video of the meeting or an audio of the meeting, and acquiring a meeting collection note associated with the meeting information.

Optionally, the method further includes: acquiring a note image of a recorded note corresponding to the meeting information, identifying the note image and acquiring the meeting collection note.

Specifically, the note image may be identified by using the optical recognition technology to acquire the meeting collection note.

Optionally, the method further includes: acquiring a personal information image of an attendee, identifying the personal information image and acquiring the personal information of the attendee.

Specifically, the personal information image may be identified by using the optical recognition technology to acquire the personal information of the attendee.

Optionally, the method further includes: performing information exchange with at least one second user through attendee information of the at least one second user for a first user, where the attendee information includes business card information of the attendees, and sharing meeting-attended information and business card information of the first user with the at least one second user, where the meeting-attended information includes at least one of meeting audio and video information, or collection note information.

Optionally, the step 203 includes: outputting business card information of the attendees to the display.

The meeting information, the meeting association information and the personal information of the attendee may be outputted to the display.

According to the meeting management method of the embodiment of the present disclosure, meeting information stored according to time on a calendar sent by a server is received, meeting association information associated with the meeting information sent by the server is received; personal information of an attendee sent by the server is received; and an association relationship sent by the server is received, where the association relationship is an association relationship among the meeting information, the meeting association information and the personal information of the attendee.

The unified storage and management of the meeting association information may be achieved in the embodiments of the present disclosure. When searching for the meeting information later, the corresponding meeting association information may be searched directly based on the established association relationship. The meeting information is organized and clear, and the search process is simple, thereby improving the efficiency of searching the meeting information.

A server is further provided, including: a memory, a processor and a computer program stored on the memory and capable of running on the processor. The computer program is executed by the processor to implement: sending meeting information stored according to time on a calendar to a terminal, where the meeting information includes at least one of time of a meeting, a location of the meeting, a type of the meeting, a topic of the meeting, or attendees; sending meeting association information associated with the meeting information to the terminal; sending personal information of an attendee to the terminal; and sending an association relationship to the terminal, where the association relationship is an association relationship among the meeting information, the meeting association information and the personal information of the attendee.

FIG. 10 is a flowchart of steps of a meeting management method according to another embodiment of the present disclosure.

The meeting management method includes: step 401, sending meeting information stored according to time on a calendar to a terminal, where the meeting information includes at least one of time of a meeting, a location of the meeting, a type of the meeting, a topic of the meeting, or attendees; step 402, sending meeting association information associated with the meeting information to the terminal; step 403, sending personal information of an attendee to the terminal; and step 404, sending an association relationship to the terminal, where the association relationship is an association relationship among the meeting information, the meeting association information and the personal information of the attendee.

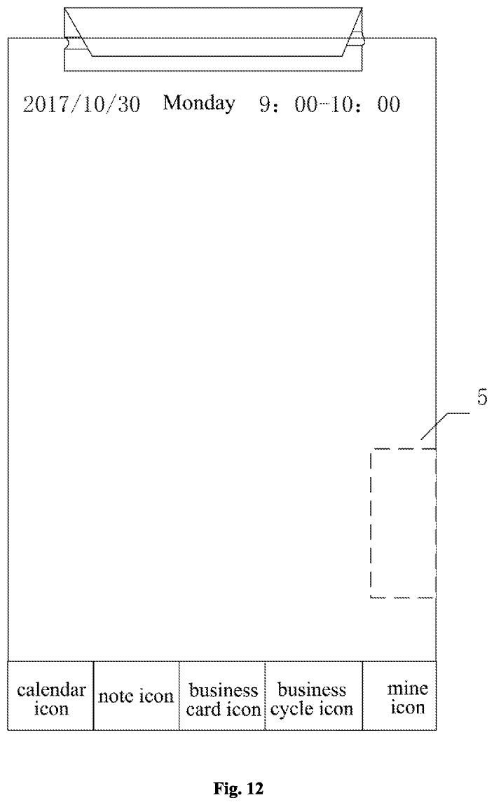

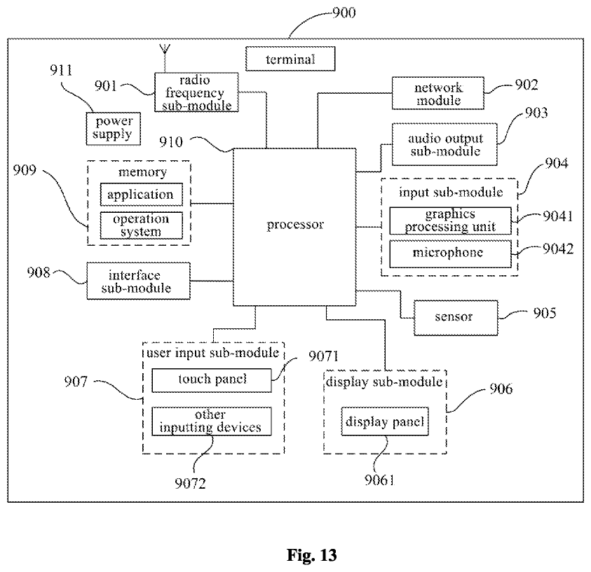

In the following embodiment, the terminal will be described in detail with reference to FIG. 12 and FIG. 13.

FIG. 13 is a schematic diagram of a hardware structure of a terminal according to an embodiment of the present disclosure.

As shown in FIG. 11 and FIG. 12, the meeting notebook may include a display screen 1, an electronic pen slot 2, an electronic pen 4, a clip 3 and a side slot 5.

The display screen 1 may be a touch screen. The display screen 1 may be any one of a liquid crystal display (LCD) screen, an organic light-emitting diode (OLED) screen, a quantum dot screen, an electronic paper screen.

A touch mode of the display screen 1 may be capacitive or magnetron. Specifically, the touch mode of the display screen 1 may be determined according to service requirements, which is not defined in the embodiment of the present disclosure.

The user may touch the display screen 1 by using a finger, or by using the electronic pen 4, so as to record the meeting content, and record the business card information of another attendee as well, thereby to store the meeting content and/or the business card information of another attendee.

The electronic pen 4 may be placed in the electronic pen slot 2 when not in use, and fixed by the clip 3, so as to prevent the electronic pen 4 from sliding out and missing.

Of course, when the electronic pen 4 is located in the electronic pen slot 2, the electronic pen 4 may further be used as an external antenna for the meeting notebook to provide a better signal for the meeting notebook.

The side slot 5 may be used to hold a paper business card.

It should be appreciated that, the side slot 5 may be set on any side edge of the meeting notebook. Specifically, it may be determined according to service requirements, which is not defined in the embodiment of the present disclosure.

In a morning meeting which multiple attendees attend, an attendee may receive paper business cards sent by other attendees, and the attendee may temporarily store the paper business cards sent by other attendees in the side slot 5, thereby showing respect to other attendees while storing the paper business cards.

Through the terminal in the embodiments of the present disclosure, the user may record important content of the meeting easily. Compared with the paper notebook, the convenience and efficiency of searching the meeting recording information later may be improved, thereby improving the usage experience.

A non-transitory computer readable storage medium having a computer program stored thereon is further provided, the computer program is executed by a processor to implement: receiving meeting information stored according to time on a calendar sent by a server, where the meeting information includes at least one of time of a meeting, a location of the meeting, a type of the meeting, a topic of the meeting, or attendees; receiving meeting association information associated with the meeting information sent by the server; receiving personal information of an attendee sent by the server; and receiving an association relationship sent by the server, where the association relationship is an association relationship among the meeting information, the meeting association information and the personal information of the attendee.

A non-transitory computer readable storage medium having a computer program stored thereon is further provided, the computer program is executed by a processor to implement: sending meeting information stored according to time on a calendar to a terminal, where the meeting information includes at least one of time of a meeting, a location of the meeting, a type of the meeting, a topic of the meeting, or attendees; sending meeting association information associated with the meeting information to the terminal; sending personal information of an attendee to the terminal; and sending an association relationship to the terminal, where the association relationship is an association relationship among the meeting information, the meeting association information and the personal information of the attendee.

FIG. 13 is a schematic diagram of a hardware structure of a terminal according to an embodiment of the present disclosure. A terminal 900 includes but not limited to: a radio frequency sub-module 901, a network module 902, an audio output sub-module 903, an input sub-module 904, a sensor 905, a display sub-module 906, a user input sub-module 907, an interface sub-module 908, a memory 909, a processor 910, a power supply 911 and other components. The skilled in the art may understand that the terminal is not limited by the structure of the terminal shown in FIG. 13, but may include more or less components than components in the structure shown in FIG. 13, or may combine some components in the structure shown in FIG. 13, or may have a component arrangement different from a component arrangement in the structure shown in FIG. 13. In the embodiment of the present disclosure, the terminal includes but not limited to a mobile phone, a tablet personal computer, a notebook computer, a palmtop computer, a vehicle-mounted terminal or a wearable device.

The processor 910 is used to receiving meeting information stored according to time on a calendar sent by a server, where the meeting information includes at least one of time of a meeting, a location of the meeting, a type of the meeting, a topic of the meeting, or attendees; receiving meeting association information associated with the meeting information sent by the server; receiving personal information of an attendee sent by the server; and receiving an association relationship sent by the server, where the association relationship is an association relationship among the meeting information, the meeting association information and the personal information of the attendee.

Optionally, the processor 910 is further used to establish an association relationship between the received meeting information and time on the calendar.

Optionally, the processor 910 is further used to receive meeting abstract information, and acquire the meeting information from the meeting abstract information. The meeting abstract information includes at least one of the time of the meeting, the location of the meeting, the type of the meeting, the topic of the meeting, or the attendees.

Optionally, the processor 910 is further used to generate a meeting link associated with the meeting information.

Optionally, the processor 910 is further used to receive meeting information corresponding to the meeting link.

Optionally, the processor 910 is further used to acquire multi-media information associated with the meeting information, where the multi-media information includes at least one of a picture of the meeting, a video of the meeting or an audio of the meeting.

Optionally, the processor 910 is further used to acquire a meeting collection note associated with the meeting information.

Optionally, the processor 910 is further used to perform information exchange with at least one second user through attendee information of the at least one second user for a first user, where the attendee information includes business card information of the attendees.

Optionally, the processor 910 is further used to share meeting-attended information and business card information of the first user with the at least one second user, where the meeting-attended information includes at least one of meeting audio and video information, or collection note information.

Optionally, the processor 910 is further used to output business card information of the attendees to the display.

It should be appreciated that, in some embodiments of the present disclosure, the radio frequency sub-module 901 may be used to transmit and receive signals during an information transmitting and receiving process or a call process. The radio frequency sub-module 901 may receive downlink data from a base station and transmit the downlink data to the processors 910. In addition, the radio frequency sub-module 901 may transmit uplink data to the base station. Usually, the radio frequency sub-module 901 includes, but is not limited to, an antenna, at least one amplifier, a transceiver, a coupler, a Low Noise Amplifier (LNA), a duplexer etc. In addition, the radio frequency sub-module 901 may also communicate with a network and other communication devices through wireless communication.

The terminal 900 may provide the user with an access to a wireless broadband internet through the network module 902. For example, the user may transmit and receive an Email, browse a webpage and access a streaming media.

The audio output sub-module 903 may convert audio data received by the radio frequency sub-module 901 or the network module 902 or stored in the memory 909 into audio signals and output as sound. Moreover, the audio output sub-module 903 may further provide an audio output related to a specific function performed by the terminal 900 (for example, a call signal reception sound, a message reception sound, etc.). The audio output sub-module 903 includes a speaker, a buzzer, and a receiver, etc.

The input sub-module 904 is used to receive audio or video signals. The input sub-module 904 may include a graphics processing unit (GPU) 9041 and a microphone 9042. The graphics processing unit 9041 is configured to process image data of pictures or videos acquired by an image capturing device (such as a camera) in a video capturing mode or an image capturing mode. A processed image frame may be displayed on the display sub-module 906. The image frame processed by the graphics processing unit 9041 may be stored in the memory 909 (or other storage medium) or sent via the radio frequency sub-module 901 or the network module 902. The microphone 9042 may receive sound, and may process the sound into audio data. The processed audio data may be converted into a format that may be sent to a mobile communication base station via the radio frequency sub-module 901 in the case of a telephone call mode.

The terminal 900 further includes at least one sensor 905, such as a light sensor, a motion sensor and other sensors. The light sensor may include an ambient light sensor and a proximity sensor. The ambient light sensor may adjust the brightness of the display panel 9061 according to the brightness of ambient light. The proximity sensor may close the display panel 9061 and/or become backlit when the terminal 900 is moved to an ear. As one kind of motion sensor, an accelerometer sensor may detect a value of acceleration on each of all directions (typically three-axis). The accelerometer sensor may detect the value and direction of gravity in stationary, identify a posture of the terminal (such as switch between a horizontal screen and a vertical screen, a related game, magnetometer posture calibration and so on), and implement a vibration recognition related function (such as a pedometer and a percussion). The sensor 905 may further include a fingerprint sensor, a pressure sensor, an iris sensor, a molecular sensor, a gyroscope, a barometer, a hygrometer, a thermometer, an infrared sensor, etc. To avoid repetition, details are not described herein again.

The display sub-module 906 may display information inputted by the user or provided to the user. The display sub-module 906 may include a display panel 9061, which may be configured in the form of a Liquid Crystal Display (LCD) and an Organic Light-Emitting Diode (OLED), etc.

The user input sub-module 907 may receive inputted numeral or character information, and generate signal input related with user configuration of the terminal and function control. Specifically, the user input sub-module 907 may include a touch panel 9071 and other inputting devices 9072. The touch panel 9071 is also called a touch screen, and may collect a touch operation performed by a user on or near the touch panel 9071 (e.g., the user performs an operation on or near the touch panel 9071 with any suitable object or accessory such as a finger and a touch pen). The touch panel 9071 may include a touch detection apparatus and a touch controller. The touch detection apparatus may detect a touch position of the user, detect a signal generated based on the touch operation, and transmit the signal to the touch controller. The touch controller may receive touch information from a touch detection apparatus, convert the touch information into a touch point coordinate, transmit the touch point coordinate to the processor 910, and receive and execute a command sent by the processor 910. In addition, the touch panel 9071 may be implemented by multiple modes such as a resistive mode, a capacitive mode, an infrared mode or a surface acoustic wave mode. Besides the touch panel 9071, the user input sub-module 907 may further include other inputting devices 9072. Specifically, other inputting devices 9072 may include, but are not limited to, a physical keyboard, a function key (such as a volume control key, a switch key etc.), a trackball, a mouse and an operating lever. To avoid repetition, details are not described herein again.

Further, the display panel 9061 may be covered with the touch panel 9071. When detecting the touch operation on or near the touch panel 9071, the touch panel 9071 transmits the touch operation to the processor 910 to determine the type of the touch event. Afterwards, the processor 910 provides a video output on the display panel 9061 according to the type of the touch event. Although the touch panel 9071 and the display panel 9071 are used as two independent components to implement an inputting function and an outputting function of the terminal respectively in FIG. 6, in some examples, the touch panel 9071 and the display panel 9061 may be integrated to implement the inputting function and the outputting function of the terminal, which is not defined in specific herein.

The interface sub-module 908 is an interface for connecting an external device and the terminal 900. For example, the external device may include a wired or wireless headset port, an external power supply (or a battery charger) port, a wired or wireless data port, a memory card port, a port for connecting a device with an identification module, an audio input/output (I/O) port, a video I/O port, a headphone port, etc. The interface sub-module 908 may be used to receive an input (for example, data information, power, etc.) from the external device and transmit the received input to one or more elements in the terminal 900 or may be used to transmit data between the terminal 900 and the external device.

The storage 909 may store software programs and various data. The storage 909 may include: a program storage area and a data storage area. The program storage area may store an operation system and an application for implementing at least one function (e.g., an audio playing function, a video playing function and so on). The data storage area may store data created when a phone is used (e.g., audio data, contact data and so on). In addition, the storage 909 may include a high-speed random access memory and a non-transitory memory such as at least one disk storage device, flash device or a transitory solid-state storage device.

The processor 910 is a control center of the terminal, and is connected with all components of the terminal via various interfaces and circuits, and may implement various functions and data processing of the terminal through operating or executing the software programs and/or modules stored in the storage 909 and calling data stored in the storage 909, thereby perform an overall monitoring on the terminal. The processor 910 may include one or more processing sub-module. Optionally, the processor 910 may include an application processor and a modem processor. The application processor may process an operation system, a user interface and applications. The modem processor may process wireless communication. It should be appreciated that, the processor 910 may not include the modem processor.

The terminal 900 may further include a power supply 911 (such as a battery) for supplying power to various components. Optionally, the power 190 may be connected with the processor 910 through a power management system, so as to manage such functions as charging, discharging and power consumption through the power management system.

In addition, the terminal 900 includes some functional modules not shown. To avoid repetition, details are not described herein again.

It should be noted that the terms “include”, “have”, or any variation thereof used herein are intended to cover a non-exclusive inclusion, such that a process, a method, an article, or a device that includes a list of elements not only includes the list of elements, but also may include other elements not expressly listed or include elements inherent in the process, the method, the article, or the device. In a case that there is no further limitation, an element preceded by “includes or including” does not preclude existence of additional identical elements in the process, the method, the article, or the device including the element.

According to the foregoing description of the embodiments, a person skilled in the art may clearly understand that the methods in the foregoing embodiments may be implemented by using software in combination with a necessary common hardware platform, and certainly may alternatively be implemented by using hardware. However, in most cases, the former is a preferred embodiment. Based on such an understanding, the technical solutions of the present disclosure essentially or the part contributing to the related art may be implemented in a form of a software product. The software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this disclosure

For the sake of simple description, all the foregoing method embodiments are expressed as combinations of a series of operations. A person skilled in the art should be aware that the present disclosure is not limited by the described sequence of operations, because some steps may be performed in other order or simultaneously according to the present disclosure. Further, a person skilled in the art should also be aware that the embodiments described in the specification are optional embodiments, and the operations and modules involved are not necessarily required by the present disclosure.

Each embodiment in the specification is described in a progressive manner and focuses on the differences from other embodiments. For the description of same or similar parts between various embodiments, a cross-reference may be made to the embodiments.

Finally, it should be noted that in the present disclosure, relational terms such as first and second are used only to distinguish one entity or operation from another entity or operation, and do not necessarily require or imply that there is any such actual relationship or order between the entities or operations. Moreover, a term “include”, “have” or any other variation thereof are intended to encompass non-exclusive inclusion, such that a process, method, product or device including a series of elements includes not only those elements, but also other elements not explicitly listed, or elements inherent to the process, method, product or device. Without more restrictions, an element defined by an expression “including a . . . ” does not exclude the existence of other identical elements in the process, method, product or device including the element.

The terminal, the display device, and the meeting management method and the meeting notebook provided in the present disclosure are described in detail above. Specific examples are used herein to explain the principle and implementation of the present disclosure. The description of the above embodiments is only meant to facilitate the understanding of the method of the present disclosure and its core ideas; and modifications may be made in the specific implementations and applications by a person of ordinary skill in the art according to the ideas of the present disclosure. Therefore, the contents of the description should not be construed as a limitation of the present disclosure.

What is claimed is:

1. A terminal, comprising a display, a memory and a processor; wherein,
the memory stores program codes capable of implementing the following functions: a calendar management module, a note management module, a business card management module and an association relationship management module;
the processor is configured to execute the program codes of the calendar management module, the note management module, the business card management module and the association relationship management module;
the display is configured to display information outputted by the calendar management module, the note management module, the business card management module and the association relationship management module, and acquire input information according to an operation of a user on the display;
the calendar management module is configured, when executed by the processor, to receive meeting information stored according to time on a calendar sent by a server, wherein the meeting information comprises at least one of time of a meeting, a location of the meeting, a type of the meeting, a topic of the meeting, or attendees;
the note management module is configured, when executed by the processor, to receive meeting association information associated with the meeting information sent by the server;
the business card management module is configured, when executed by the processor, to receive personal information of an attendee sent by the server; and
the association relationship management module is configured, when executed by the processor, to receive an association relationship sent by the server, wherein the association relationship is an association relationship among the meeting information, the meeting association information and the personal information of the attendee.

2. The terminal according to claim 1, wherein the calendar management module comprises the following sub-modules executed by the processor: a time association sub-module, configured to establish an association relationship between the received meeting information and the time on the calendar when executed by the processor; and a meeting abstract viewing sub-module, configured to receive meeting abstract information, and acquire the meeting information from the meeting abstract information when executed by the processor; wherein the meeting abstract information comprises at least one of the time of the meeting, the location of the meeting, the type of the meeting, the topic of the meeting, or the attendees.

3. The terminal according to claim 1, further comprising: a meeting link generation module, configured to generate a meeting link associated with the meeting information when executed by the processor; and a meeting link processing module, configured to receive the meeting information corresponding to the meeting link when executed by the processor.

4. The terminal according to claim 1, wherein the note management module comprises: a multi-media information acquisition sub-module, configured to acquire multi-media information associated with the meeting information when executed by the processor; wherein the multi-media information comprises at least one of a picture of the meeting, a video of the meeting or an audio of the meeting; and a meeting note acquisition sub-module, configured to acquire a meeting collection note associated with the meeting information when executed by the processor.

5. The terminal according to claim 4, further comprising: a first image acquisition module, wherein the first image acquisition module is a camera and configured to acquire a note image of a recorded note corresponding to the meeting information; and a first image identification module implemented by a computer program, configured to identify the note image and acquire the meeting collection note when codes are executed by the processor.

6. The terminal according to claim 1, further comprising: a second image acquisition module, wherein the first image acquisition module is a camera and configured to acquire a personal information image of the attendee; and a second image identification module, configured to identify the personal information image and acquire the personal information of the attendee when executed by the processor.

7. The terminal according to claim 1, further comprising: an information exchange module and an information sharing module, wherein, the information exchange module is configured, when executed by the processor, to perform information exchange with at least one second user through attendee information of the at least one second user for a first user, and the attendee information comprises business card information of the attendee;
the information sharing module is configured, when executed by the processor, to share meeting-attended information and business card information of the first user with the at least one second user, and the meeting-attended information comprises at least one of meeting audio and video information, or collection note information.

8. The terminal according to claim 1, wherein the business card management module comprises: a business card information output sub-module, configured to output business card information of the attendees to the display when executed by the processor.

9. The terminal according to claim 1, further comprising: an output module, configured to output the meeting information, the meeting association information and the personal information of the attendee to the display when executed by the processor.

10. A non-transitory computer readable storage medium having a computer program stored thereon, the computer program is executed by a processor to implement:
receiving meeting information stored according to time on a calendar sent by a server, wherein the meeting information comprises at least one of time of a meeting, a location of the meeting, a type of the meeting, a topic of the meeting, or attendees;
receiving meeting association information associated with the meeting information sent by the server;
receiving personal information of an attendee sent by the server; and
receiving an association relationship sent by the server, wherein the association relationship is an association relationship among the meeting information, the meeting association information and the personal information of the attendee.
